(19) United States
(12) Patent Application Publication
(10) Pub. No.: US 2015/0178749 A1
(43) Pub. Date: Jun. 25, 2015

(54) METHODS, SYSTEMS AND COMPUTER READABLE MEDIA FOR PREDICTING CONSUMER PURCHASE BEHAVIOR

(71) Applicant: MasterCard International, Inc., Purchase, NY (US)

(72) Inventors: Shen Xi Meng, Millwood, NY (US); Qian Wang, Ridgefield, CT (US); Po Hu, Norwalk, CT (US)

(73) Assignee: MASTERCARD INTERNATIONAL, INC., Purchase, NY (US)

(21) Appl. No.: 14/139,742

(22) Filed: Dec. 23, 2013

(51) Int. Cl. G06Q 30/02

(52) U.S. Cl. CPC G06Q 30/0203; G06Q 30/0255

(57) ABSTRACT

Methods, systems, and computer readable media for predicting consumer purchase behavior are disclosed. In one example, the method includes obtaining consumer intention data and purchase transaction data associated with a consumer and merging the consumer intention data with the purchase transaction data to construct a target variable. The method further includes merging the target variable with at least one independent variable to create an aggregated data set, generating an intent-action gap model utilizing a portion of the aggregated data set, and applying the intent-action gap model to the aggregated data set to generate an intent-action gap score associated with the consumer, wherein the intent-action gap score serves as an indication of purchase behavior indicator associated with the consumer.

### TECHNICAL FIELD

The subject matter described herein relates to the use of consumer transaction information and consumer intention data to generate a model for predicting the purchase behavior of a consumer. More particularly, the subject matter described herein relates to systems, methods, and computer readable media for predicting consumer purchase behavior.

### BACKGROUND

It is generally known that a gap exists between what consumers say they will purchase (i.e., consumer intention) and whether the consumers ultimately conduct the purchase (i.e., consumer action). Understanding the underlying basis of this “intent-action gap” may be very valuable to certain types of merchants, marketers, and researchers. Research in this area has also indicated that consumers frequently make purchase decisions without much forethought and not necessarily in accordance with the consumers' best interests.

Despite the fact that research related to the intent-action gap has long been conducted in academia (e.g., psychology and economy), a practical approach to incorporate a consumer's internal intention with the consumer's actual purchase action has not been found for practice in the real business world. In most cases of marketing research, intentions and actions as related to consumer behavior are investigated separately. For example, some researchers are interested in the impact of internal factors (e.g., such as attitude, motivation, and emotion) on consumer behavior while other researchers are focused directly on consumer actions.

Accordingly, there exists a need for improved systems, methods, and computer readable media for predicting consumer purchase behavior.

### SUMMARY

According to one aspect, the subject matter described herein relates to, methods, systems, and computer readable media for predicting consumer purchase behavior. In one embodiment, the method includes obtaining consumer intention data and purchase transaction data associated with a consumer and merging the consumer intention data with the purchase transaction data to construct a target variable. The method further includes merging the target variable with at least one independent variable to create an aggregated data set, generating an intent-action gap model utilizing a portion of the aggregated data set, and applying the intent-action gap model to the aggregated data set to generate an intent-action gap score associated with the consumer, wherein the intent-action gap score serves as an indication of purchase behavior indicator associated with the consumer.

The subject matter described herein may be implemented in hardware, software, firmware, or any combination thereof. As such, the terms “function”, “node”, “unit”, or “module” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for predicting consumer behavior according to an embodiment of the subject matter described herein; and

FIG. 2 is a flow chart illustrating an exemplary process for predicting consumer behavior according to an embodiment of the subject matter described herein.

### DETAILED DESCRIPTION

In accordance with the subject matter disclosed herein, methods, systems, and computer readable media for predicting consumer behavior are disclosed. The present subject matter provides a modeling approach that integrates consumer poll data (i.e., a consumer's purchase intention) and actual purchase transaction data (i.e., a consumer's purchase action) to create an “intent-action gap model” that may be used to predict the consumer's purchase behavior for certain merchant products. More specifically, an intent-action gap model may be utilized to identify a consumer that is more willing to purchase a good or service based on a consumer's previously indicated intent. Intent-action gap modeling is based on the notion that a consumer who can be characterized by a “low gap” score (i.e., a score indicating a small difference/gap between the consumer's indicated intent and subsequent purchase (or non-purchase) action) will be more likely to conduct a purchase action than a consumer that is characterized by a “large gap” score in the scenario where both consumers have indicated a desire to buy a product. Intent-action gap models may be widely employed in various marketing fields, (e.g., direct mailing, Internet advertisements, etc.) in order to target prospective consumers. Compared to traditional purchase behavior models, an intent-action gap model may enable merchant entities to better understand consumer behavior and predict purchase actions with greater accuracy.

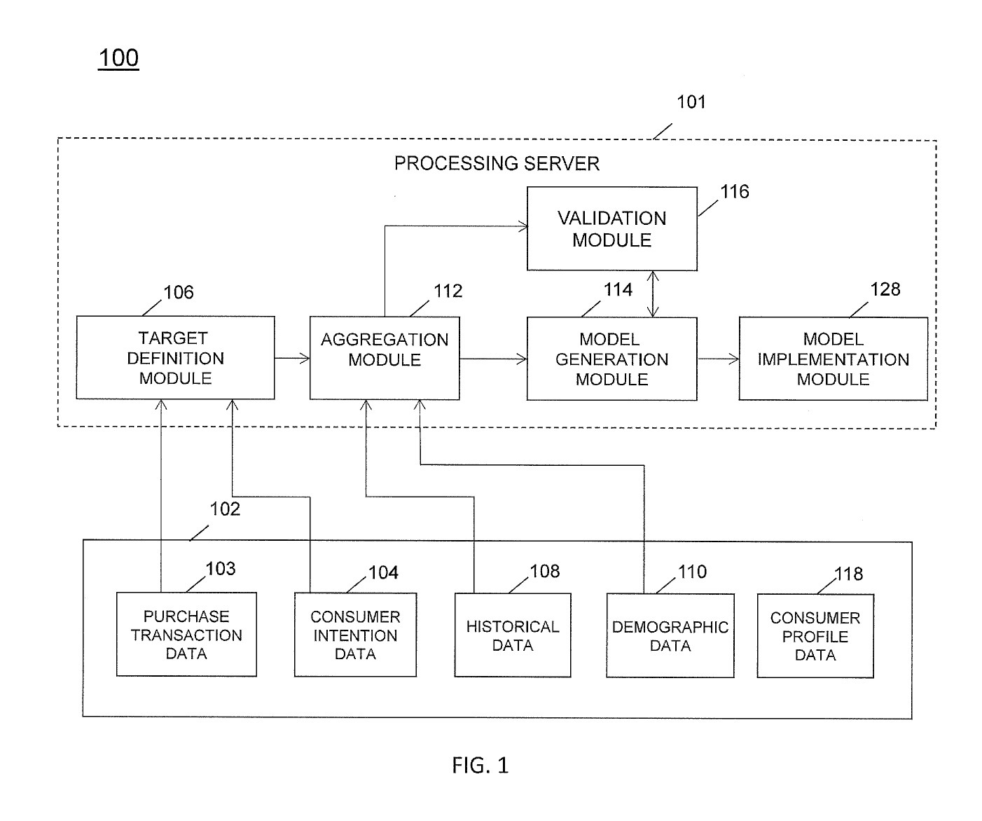

FIG. 1 illustrates an exemplary system 100 which may be used to conduct the intent-action gap profiling processes to identify consumers who are more likely to purchase goods associated based on a previous indicated intention. System 100 may include a processing server or system 101 and an enterprise data warehouse 102. In some embodiments, enterprise data warehouse 102 may include a single data storage unit that contains other data warehouses or databases that are utilized and/or created during the intent-action gap profiling process. For example, enterprise data warehouse 102 may contain a transaction database 103, a consumer intention database 104, a historical information database 108, a demographic information database 110, and a consumer profile database 118. Each of these data warehouses or databases is described below in greater detail. Alternatively, enterprise data warehouse 102 may instead depict a logical representation of a grouping of the aforementioned databases. In some embodiments, system 100 may be implemented using conventional computer hardware, processing units, and application software configurations including, for example, distributed server systems. System 100 also may include other conventional hardware and software components that are not shown in FIG. 1, such as user terminals and data warehouse query tools.

In some embodiments, enterprise data warehouse 102 includes a purchase transaction database 103. Purchase transaction database 103 may include one or more databases configured for storing processed consumer-merchant transaction data reports (e.g., actual purchase transaction data associated with a consumer). In some embodiments, each transaction data report may include account numbers identifying the consumer (e.g., a credit card holder or prepaid card holder) and other purchase transaction information, such as a transaction amount, a merchant/seller identifier, and a transaction date. In one embodiment, purchase transaction database 103 may include a MasterCard (MC) purchase transaction database that records the actual purchase transactions conducted by MasterCard credit card or prepaid card users. In some embodiments, the purchase transaction data stored in database 103 may be collected from a predefined period (e.g., 3 months) after and/or during a given customer survey poll period (see additional details below).

Consumer intention database 104 may include or more databases configured for storing consumer intention information that has been obtained from consumers via survey polls. For example, survey polls may be previously conducted for a given survey period (e.g., one month) in order to obtain data indicating a consumer's purchase intention. The survey polls may be designed to present one or more questions to a participating (e.g., opted in) consumer in order to query the consumer's intention or desire to purchase a particular product (e.g., a merchant good or service). Exemplary survey polls for collecting data related to consumer purchase intention may include an Internet or web-based questionnaire or survey, a telephone call questionnaire or survey, a printed form questionnaire or survey, a direct mailing questionnaire or survey, or any other technique that may be used to learn of a consumer's purchase intention. In some embodiments, consumer intention information is obtained from consumers who have opted-in to participate in having their purchase behavior modeled (i.e., for privacy compliance purposes).

In some embodiments, the consumer intention survey or poll may inquire the degree in which a queried consumer intends to purchase a particular product by utilizing a scaling system (e.g., a scale ranging from 1 to 7). Each number value may represent the likelihood that the consumer believes s/he will ultimately purchase the product. For example, a designated value of “1” may indicate that the consumer is definitely not going to purchase the product, 2 may indicate that the consumer is not likely to purchase the product, 3 may indicate that the consumer is somewhat unlikely to purchase the product, 4 may indicate that the consumer is uncertain to purchase the product or not, 5 may indicate that the consumer is somewhat unlikely to purchase the product, 6 may indicate that the consumer is likely to purchase the product, and 7 may indicate that the consumer will definitely purchase the product. Although the present example utilizes a scale of 1 to 7, other scales (e.g., 1 to 5, 1 to 10, 1 to 100, etc.) may be used without departing from the scope of the disclosed subject matter. Such detailed survey poll data may be collected from consumers via any means and stored in consumer intention database 104.

Historical information database 108 may include one or more databases that contain past purchase transaction records, not unlike database 103. However, historical information database 108 may be configured to store actual purchase transaction records conducted by consumers over a larger time period (e.g., 1 or more years). Like database 103, historical information database 108 may contain transaction data reports that include account numbers identifying the consumer and other purchase transaction information, such as a transaction amount, a merchant/seller identifier, and a transaction date. In some embodiments, databases 103 and 108 may be part of a common payment transaction system (e.g., MasterCard payment transaction system).

Demographic database 110 includes one or more databases that are configured to store supplemental consumer information associated with a consumer's account number contained in the purchase transaction reports in transaction data warehouse 103. The supplemental information may include such as data specific to the consumer (e.g., credit card account holder) including information such as demographic information, residential address, and ZIP code. In some embodiments, demographic information database 110 may also be provisioned with consumer information obtained from external sources. For example, demographic information database 110 may include consumer related information associated with the consumer's gender, age, ethnicity, race, marital status, disabilities, home ownership, employment status, income level, education level, and the like.

Consumer profile database 118 includes one or more databases that are configured to store consumer profile data. An exemplary consumer profile may include data fields for conventional profiling attributes and characteristics (e.g., demographic and gender attributes). In some embodiments, the consumer profile may additionally include an intent-action gap model score determined by system 100. As indicated above, an intent-action gap model score may be used as an indication of whether the consumer is likely to purchase a good based on previously indicated intent.

FIG. 1 further depicts processing server 101 as being communicatively connected to enterprise data warehouse 102. FIG. 1 depicts processing server 101 as a single entity that contains a plurality of data processing modules, such as a target definition module 106, an aggregation module 112, a model generation module 114, a validation module 116, and a model implementation module 128. In some embodiments, processing server 101 may include any server, node, or unit that is configured to process consumer related data to generate and utilize an intent-action gap model via the methods described herein. Although FIG. 1 depicts processing sever 101 as a single network element, processing server 101 may include a plurality of network elements, a plurality of network components, and/or a network itself without departing from the scope of the disclosed subject matter. For example, in an alternate embodiment, each of the aforementioned data processing modules may be respectively hosted by its own processing server and said plurality of host processing servers may compose a processing system 101. In some embodiments, processing server 101 may include a processor (not shown), such as a microprocessor, central processing unit, or any other like hardware based processor unit that is configured to execute and/or utilize the modules in processing server 101. Each of the depicted modules in processing server 101 may be stored in memory (not shown), such as random access memory (RAM), read only memory (ROM), optical read/write memory, cache memory, magnetic read/write memory, flash memory, and the like.

In some embodiments, target definition module 106 may be configured to obtain and/or receive data from both purchase transaction database 103 and consumer intention database 104. For example, target definition module 106 may query database 104 for consumer intention data and subsequently query database 103 for actual purchase transaction data (e.g., a transaction data file) that is linked to a common (i.e., same) consumer. In one embodiment, target definition module 106 may utilize a consumer's credit card account number to correlate or link the consumer intention data and the purchase transaction data. If such a link between the two data types exists, target definition module 106 may then be configured to merge the consumer intention data and the actual purchase transaction data to construct a target variable.

In some embodiments, the constructed target variable may be classified by target definition module 106 as one of three possible target variables. For example, a first target variable may be associated with a “no intent-action gap” (Yes—Do) consumer that is characterized by intent-action consistency (e.g., “I intend to purchase and I do purchase”). Because the consumers defined by this target variable follow through and purchase a product as intended, there is no “gap” between the consumer's intention and the consumer's action.

A second target variable may be associated with an “intent-action gap” (Yes—Don't) consumer that is characterized by an intent-action inconsistency (e.g., “I intend to purchase and I do not purchase”). Because the consumers defined by this target variable do not follow through and purchase a product as intended, there exists a “gap” between the consumer's intention and the consumer's action. Similarly, a third target variable may be associated with an intent-action gap (No—Do) consumer that is characterized by a different type of intent-action inconsistency (e.g., I don't intend on purchasing, but I do purchase).

In some embodiments, target definition module 106 may assign a value to a target variable based on whether the target variable is one of a i) no intent-action gap (Yes—Do) consumers, ii) intent-action gap (Yes—Don't) consumers, and iii) intent-action gap (No—Do) consumers. For the intent-action gap model, the first target variable is set to “Yes” or “1” if positive consumer intention data from database 104 is associated with actual purchase data from database 103. Similarly, the second target variable is set to “Yes” or “1” if positive consumer intention data from database 104 cannot be associated with actual purchase data from database 103. Lastly, the third target variable is set to “Yes” or “1” if negative consumer intention data from database 104 can be associated with actual purchase data from database 103. Otherwise, if the conditions of a target variable is not met, then the target variable is set to “No” or “0”.

After the target variable is created, the target variable is provided to aggregation module 112. Aggregation module 112 may also receive, in addition to the target variable, independent variables from additional sources. In some embodiments, aggregation module 112 may utilize two sets of independent variables, such as i) historical transaction data variables contained in historical information database 108 and ii) information from other sources, such as demographic information database 110. In some embodiments, historical transaction data variables from a MC historical transaction database can be used since the information is readily available and may be correlated to the consumer intention data. However, the disclosed subject matter is not limited to the use of MC transaction data, and thus historical transaction information from other sources may be utilized so long as the data may be correlated to the consumer intention data.

After obtaining the target variable from target definition module 108 and the independent variables from historical information database 108 and/or demographic database 110, aggregation module 112 may be configured to generate an aggregated data set by merging the target variable with all of the independent variables. In some embodiments, the target variable may be merged with an independent variable using a common identifier (i.e., associated with the same consumer) that was included in both the consumer intention data and the actual purchase transaction data. In some embodiments, aggregation module 112 may be configured to generate a model development data set and a validation data set by randomly selecting proportional samples or sample data from the aggregated data set. For example, aggregation module 112 may generate each of the development data set and the validation data set by randomly selecting a pool sample (e.g., 5% sample) from the aggregated data set. In some embodiments, the target variable and non-target variables may be randomly stratified into the sample data. After generating both the model development data set and the validation data set, aggregation module 112 may be configured to forward the model development data set to model generation module 114 and provide the validation data set to validation module 116.

Upon receiving the development data set from aggregation module 112, module generation module 114 may be configured to generate the intent-action gap model using the received data. For example, the intent-action gap model may be empirically developed by model generation module 114. In some embodiments, the intent-action gap model may be designed such that the model is configured to generate intent-action model scores by utilizing both consumer intent data and actual purchase transaction data. In addition, the intent-action gap model generated by module 114 may be used to generate intent-action gap scores to identify the likelihood that a consumer will purchase a product after indicating an intention to do so. In some embodiments, the generated intent-action gap score may subsequently be recorded and stored in consumer profile database 118. Likewise, the ability of the generated intent-action gap model to correctly identify the likelihood that a consumer will purchase a product after indicating an intention to do so may be assessed by conducting empirical market “lift” studies or research.

Once the intent-action gap model is created, validation module 116 conducts a model assessment procedure by utilizing the generated intent-action gap model and the validation data set. For example, validation module 116 may apply the validation data set received from aggregation module 112 to the intent-action gap model generated by module 114. In some embodiments, an intent-action gap model may be validated by training a first hash portion of the validation data set and testing with another hash portion of the validation data set, and vice versa, so that gain charts and model weights can be compared for stability using software analysis programs.

After the intent-action gap model is assessed and subsequently validated for use, model implementation module 128 may generate an intent-action gap model score for a consumer, which may subsequently be used for strategic marketing purposes. For example, the intent-action gap model may be designed to generate intent-action model scores such that a higher score indicates a greater likelihood that a consumer will purchase a product. Accordingly, a probability of a future consumer purchase made by the consumer may be estimated from the intent-action gap model scores using statistical analysis (e.g., using logistic regression algorithms). The intent-action gap model may be configured to generate simple binary scores (e.g., “Yes”=1 or “No”=0) to indicate a low or high likelihood of consumer purchase behavior, and to accordingly indicate, for example, whether the consumer should be targeted with a directed advertisement or offer to purchase a merchant product. In some embodiments, model implementation module 128 may utilize the intent-action gap model to implement the intent-action gap model score into the aggregated data set with the same independent variable for future applications. More specifically, the target variable data may not be necessary for future implementations. For example, after the model is developed, a model score equation derived from the independent variables only is created. In the event the model score is implemented to predict a consumer's purchase action in the future, only the independent variable data may be needed to generate the model score. For example, module 128 may apply the intent-action gap score to predict the likelihood of a consumer's purchase action in certain merchant products. In some embodiments, module 128 may be configured to generate a report identifying consumers having an intent-action gap score that exceeds a predefined threshold. Such a threshold may be used to identify consumers that are more likely to purchase goods, thereby enabling more efficient and accurate marketing techniques.

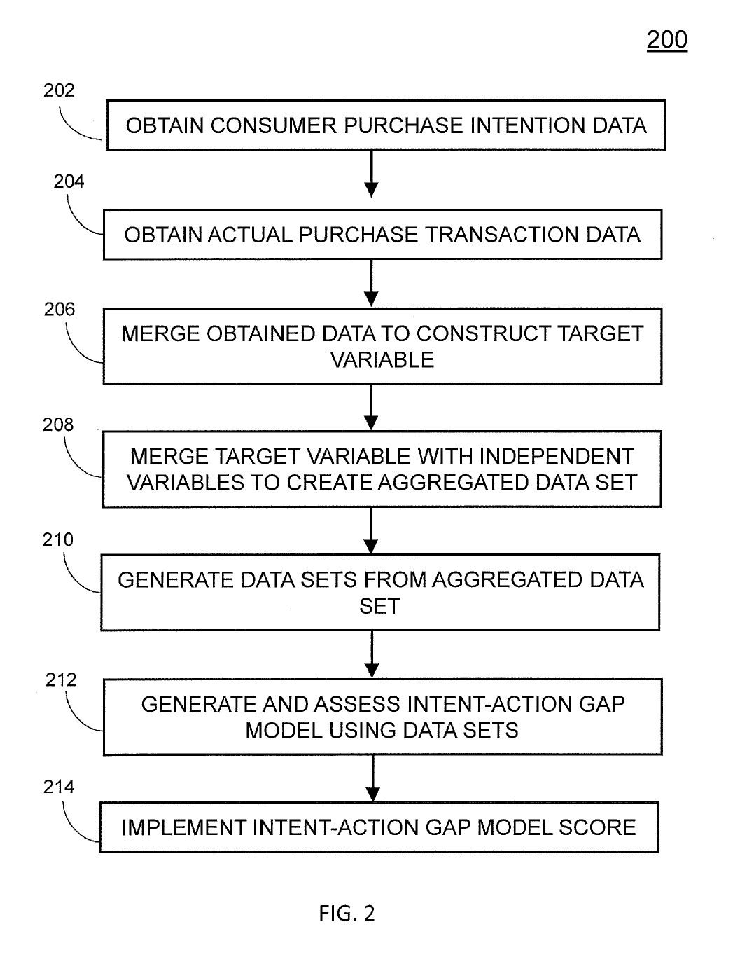

FIG. 2 is a flow chart illustrating an exemplary method 200 for defining a relationship between the intention and action to predict consumer purchase behavior according to an embodiment of the subject matter described herein. In step 202, consumer intention data is obtained. In some embodiments, a target definition module in a processing server may be configured to access a consumer intention database that is configured to store consumer intention data that has been collected or provisioned over a defined time period (e.g., one month). In some embodiments, the consumer intention data includes answers from survey polls (e.g., Internet based questionnaires) designed to obtain purchase intention data from a consumer. In some examples, the consumer intention data may also include an indicator that represents the degree in which the consumer intends to make a purchase (e.g., a scale from 1 to 7).

In step 204, actual consumer purchase data is collected. In some embodiments, the target definition module may be configured to query a purchase transaction database to obtain actual purchase data to confirm the purchase action. Exemplary purchase transaction data may include credit card transaction data, purchase record data from Internet websites, and the like.

In step 206, the consumer intention data and the consumer purchase data are merged to construct a target variable. In some embodiments, the consumer intention data obtained in step 202 and the consumer purchase data obtained in step 204 are correlated and linked to each other by the target definition module. For example, the consumer intention data and the actual purchase data may be linked or merged using a common identifier associated with a single consumer, such as the consumer's credit card account number (if allowed by the consumer) or some other (legally complying) consumer identifier or account number that is present in both sets of data.

Once the consumer intention data and consumer purchase data are merged (i.e., matched), the target definition module may construct a target variable. In some embodiments, the target variable may be associated with no intent-action gap (Yes—Do) consumers that are characterized by intent-action consistency (e.g., I will purchase and I do purchase), intent-action gap (Yes—Don't) consumers that are characterized by intent-action inconsistency (e.g., I will purchase and I do not purchase), or intent-action gap (Yes—Don't) consumers that are characterized by intent-action inconsistency (e.g., I won't purchase and I do purchase).

In step 208, the target variable and independent variables are merged into an aggregated data set. In some embodiments, the target variables, consumer historical data variables, and/or demographic variables are all merged (e.g., rolled up and aggregated) into an aggregated data set by an aggregation module.

In step 210, development data sets and validation data sets for the intent-action gap model are generated. In some embodiments, proportional samples are selected and assigned into a development data set and a validation data set by the aggregation module.

In step 212, the intent-action gap model is generated and assessed. In some embodiments, the intent-action gap model is initially developed in the development data by a model generation module. Once developed, the performance of the intent-action gap model is subsequently assessed using the validation data set by a validation module.

In step 214, the model score is implemented into the aggregated data. In some embodiments, a model implementation module implements the intent-action gap model score into the aggregated data, or some other snapshot data that includes the same independent variables for the further applications. For example, intent-action gap scores determined by the model implementation module may be used to determine the likelihood of a purchase action by a consumer with respect to certain merchant products.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for predicting consumer purchase behavior, the method comprising:
obtaining consumer intention data and purchase transaction data associated with a consumer;
merging the consumer intention data with the purchase transaction data to construct a target variable;
merging the target variable with at least one independent variable to create an aggregated data set;
generating an intent-action gap model utilizing a portion of the aggregated data set; and
applying the intent-action gap model to the aggregated data set to generate an intent-action gap score associated with the consumer, wherein the intent-action gap score serves as an indication of purchase behavior indicator associated with the consumer.

2. The method of claim 1 wherein the consumer intention data includes information obtained from written survey data, telephonic survey data, or Internet survey data provided by the consumer.

3. The method of claim 1 wherein the purchase transaction data includes transaction data records that represent payment transactions made by the consumer.

4. The method of claim 1 wherein the target variable is associated with one of: a no intent-action gap consumer, an intent-action gap (Yes—Don't) consumer, or an intent-action gap (No—Do) consumer.

5. The method of claim 1 wherein the at least one independent variable includes historical purchase transaction data associated with the consumer.

6. The method of claim 5 wherein the at least one independent variable includes demographic data associated with the consumer

7. The method of claim 1 comprising generating a report identifying at least one consumer having an intent-action gap score that exceeds a predefined threshold.

8. The method of claim 1 comprising validating the intent-action gap model utilizing a second portion of the aggregated data set.

9. The method of claim 1 comprising implementing the intent-action gap score by directing product advertisement to the consumer.

10. The method of claim 9 comprising directing the product advertisement to the consumer via at least one of a direct mailing and an Internet ad.

11. A system for predicting consumer purchase behavior, the system comprising:
a target definition module configure to obtain consumer intention data and purchase transaction data associated with a consumer and to merge the consumer intention data with the purchase transaction data to construct a target variable;
an aggregation module configured to receive the target variable from the target definition module and to merge the target variable with at least one independent variable to create an aggregated data set;
a model generation module configured to receive the a portion of the aggregated data set from the aggregation module and to generate an intent-action gap model utilizing the portion of the aggregated data set; and
a model implementation module configure to apply the intent-action gap model to the aggregated data set to generate an intent-action gap score associated with the consumer, wherein the intent-action gap score serves as an indication of purchase behavior indicator associated with the consumer.

12. The system of claim 11 wherein the consumer intention data includes information obtained from written survey data, telephonic survey data, or Internet survey data provided by the consumer.

13. The system of claim 11 wherein the purchase transaction data includes transaction data records that represent payment transactions made by the consumer.

14. The system of claim 11 wherein the target variable is associated with one of: a no intent-action gap consumer, an intent-action gap (Yes—Don't) consumer, or an intent-action gap (No—Do) consumer.

15. The system of claim 11 wherein the at least one independent variable includes historical purchase transaction data associated with the consumer.

16. The system of claim 15 wherein the at least one independent variable includes demographic data associated with the consumer

17. The system of claim 11 wherein the model implementation module is further configured to generate a report identifying at least one consumer having an intent-action gap score that exceeds a predefined threshold.

18. The system of claim 11 comprising a validation module configured to receive a second portion of the aggregated data set from the aggregation module and to validate the intent-action gap model utilizing the second portion of the aggregated data set.

19. The system of claim 11 wherein the model implementation module is further configured to implement the intent-action gap score by directing a product advertisement to the consumer.

20. The system of claim 19 wherein the model implementation module is further configured to direct the product advertisement to the consumer via at least one of a direct mailing and an Internet ad.

21. A non-transitory computer readable medium having stored thereon executable instructions for controlling a computer to perform steps comprising:
obtaining consumer intention data and purchase transaction data associated with a consumer;
merging the consumer intention data with the purchase transaction data to construct a target variable;
merging the target variable with at least one independent variable to create an aggregated data set;
generating an intent-action gap model utilizing a portion of the aggregated data set; and
applying the intent-action gap model to the aggregated data set to generate an intent-action gap score associated with the consumer, wherein the intent-action gap score serves as an indication of purchase behavior indicator associated with the consumer.
